(19) United States
(12) Patent Application Publication
(10) Pub. No.: US 2022/0162123 A1
(43) Pub. Date: May 26, 2022

(54) COMPOSITION FOR MANUFACTURING METHYLENE MALONATE CEMENTITIOUS HYBRID SYSTEMS, THE PREPARATION THEREOF AND USE OF THE SAME IN CONSTRUCTION

(71) Applicant: BASF SE, Ludwigshafen am Rhein (DE)

(72) Inventors: Lei MENG, Shanghai (CN); ShengZhong ZHOU, Shanghai (CN); Harald ROECKEL, Muenster (DE)

(21) Appl. No.: 17/430,870

(22) PCT Filed: Jan. 31, 2020
(86) PCT No.: PCT/EP2020/052452

§ 371 Date: Aug. 13, 2021

(30) Foreign Application Priority Data
Feb. 13, 2019 (CN) PCT/CN2019/074956

(51) Int. Cl. C04B 28/02; C04B 24/04; C04B 24/16; C04B 22/14; C04B 40/06; C04B 40/00

(52) U.S. Cl. CPC C04B 28/02; C04B 24/045; C04B 24/16; C04B 2111/60; C04B 40/065; C04B 40/0046; C04B 22/141

(57) ABSTRACT

The present invention relates to a composition for manufacturing methylene malonate cementitious hybrid systems. Particularly, the invention relates to a composition comprising at least one methylene malonate monomer (A), at least one methylene malonate polymer (B), at least one acidic stabilizer (C), and cement (D), to the preparation thereof, and to the use of the composition in construction, particularly as a surface protection material, a structural consolidation material or as a material used in underground constructions.

### TECHNICAL FIELD

The present invention relates to a composition for manufacturing methylene malonate cementitious hybrid systems. Particularly, the invention relates to a composition comprising (A) at least one methylene malonate monomer, (B) at least one methylene malonate polymer, (C) at least one acidic stabilizer, and (D) cement, to the preparation thereof, and to the use of the composition in construction, particularly as a surface protection or structural consolidation material, more particularly in flooring, coating, roofing, wall paint, screed, primer, waterproofing, grouting, anchoring, and underground constructions.

### BACKGROUND

Constructions under humid environment, for example coating a wet surface or grouting a damp structure, are considerably difficult in that conventional coating or grouting materials such as cement is generally not readily cured in high humidity. It is even more challenging for works performed under water.

Some polymers have been introduced to a cementitious system to improve the grouting performance. CN102515651 discloses a cement-based aqueous epoxy grouting material comprising epoxy resin, diluent, defoaming agent, coupling agent, water-soluble amine curing agent, cement, river sand, admixture etc. having improved mechanical compressive strength and flexural strength and curing capability in humid conditions. CN105176002 discloses another grouting material comprising resin component A and hardener component B, wherein component A comprising: bisphenol F epoxy resins, epoxy-butoxy glycidyl ether, butyl glycidyl ether epoxy resin, organic silane coupling agent, OP-10 surfactant, and an aqueous long oil alkyd resin, and hardener component B comprising: CNSL curing agent, polyetheramine, DMP-30, benzyl alcohol, and cobalt naphthenate. This cement-free grouting material will not be affected by moisture and can be cured under water. However, both epoxy-based grouting materials have difficulty curing at low temperature and the curing process lasts several days. For instance, the cement-based aqueous epoxy grouting material disclosed in CN102515651 needs to be cured at temperature above 5° C. for over three days. Therefore, they are not suitable for applications requiring a fast curing speed and good early strength.

Therefore, it is expected in the construction field to provide a composition that is simple for handling, fast curing in a wide range of temperature and humidity, good early strength, and, at the same time, has expected performances including good waterproofing, chemical resistance, bonding and mechanical properties.

### SUMMARY OF THE PRESENT INVENTION

An object of this invention is to provide a composition which, when used in constructions, does not have the above deficiencies in the prior arts. Particularly, an object of this invention is to provide a novel composition, wherein the methylene malonate monomer, the polymer thereof and cement are mixed in a specific ratio and undergo fast curing. Said composition can be applied in an extreme condition, such as at a low temperature and a high humidity level, and thus is suitable for use in wet conditions or even under water. The resulting cured product is substantially a 100% solid compound with little or substantially no solvent, and shows excellent performances in terms of early strength, curing speed, chemical resistance, and the like.

Surprisingly, it has been found by the inventors that the above objects can be achieved by a composition comprising:

(A) at least one methylene malonate monomer;

(B) at least one methylene malonate polymer;

(C) at least one acidic stabilizer; and

(D) cement.

Particularly, the above objects can be solved by a composition comprising:

(A) at least one methylene malonate monomer having formula (I),

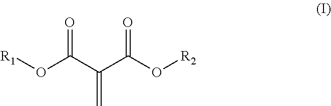

wherein, R₁ and R₂ are in each case independently selected from the group consisting of C1-C30-alkyl, C2-C30-alkenyl, C3-C30-cyclolalkyl, C2-C30-heterocyclyl, C2-C30-heterocyclyl-(C1-C30-alkyl), C6-C30-aryl, C6-C30-aryl-C1-C30-alkyl, C2-C30-heteroaryl, C2-C30-heteroaryl-C1-C30-alkyl, C1-C30-alkoxy-C1-C30-alkyl, halo-C1-C30-alkyl, halo-C2-C30-alkenyl, and halo-C3-C30-cyclolalkyl, each of which radicals is optionally substituted, the heteroatom being selected from N, O and S;

(B) at least one methylene malonate polymer having formula (II),

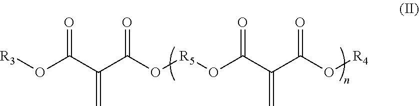

wherein, R₃ and R₄ are, in each case independently selected from the group consisting of C1-C30-alkyl, C2-C30-alkenyl, C3-C30-cyclolalkyl, C2-C30-heterocyclyl, C2-C30-heterocyclyl-(C1-C30-alkyl), C6-C30-aryl, C6-C30-aryl-C1-C30-alkyl, C2-C30-heteroaryl, C2-C30-heteroaryl-C1-C30-alkyl, C1-C30-alkoxy-C1-C30-alkyl, halo-C1-C30-alkyl, halo-C2-C30-alkenyl, and halo-C3-C30-cyclolalkyl, each of which radicals is optionally substituted, the heteroatom being selected from N, O and S;

n is an integer from 1 to 20;

R₅, if n=1 is, or if n >1 are in each case independently, selected from the group consisting of C1-C30-alkylene, C2-C30-alkenylene, C2-C30-alkynylene, C6-C30-arylene, C3-C30-cyclolalkylene, C5-C30-cyclolalkenylene, C5-C30-cyclolalkynylene, C2-C30-heterocyclylene, and C2-C30-heteroarylene, each of which radicals is optionally substituted, the heteroatom being selected from N, O and S, wherein R₅ is optionally interrupted by a radical selected from N, O and S;

(C) at least one acidic stabilizer; and

(D) cement;

wherein, the monomer (A) is in an amount of from 0 to 70 wt. % based on the total weight of the monomer (A) and the polymer (B);

the acidic stabilizer (C) is in an amount of from 0.1 to 500 ppm, preferably from 0.1 to 300 ppm and more preferably from 0.1 to 200 ppm, and most preferably from 0.1 to 100 ppm; and

cement (D) is in an amount of from 1% to 70 wt. % based on the total weight of the composition.

In a further aspect, the invention relates to a mixture comprising the composition according to the invention.

The composition may be prepared by a process comprising steps of:

(1) mixing the monomer (A), the polymer (B) and the acidic stabilizer (C); and

(2) mixing the cement (D) with the mixture obtained in step (1) to obtain the composition.

It has been surprisingly found that the composition according to this invention can be cured within a short period of time, at a low temperature, and in wet conditions or even under water. The cured composition thus-obtained exhibits good early strength, sufficient bonding strength, tensile strength, waterproofing ability, chemical resistance and thus are suitable as a construction material requiring good curing performance in wet conditions, such as a surface protection material used as flooring or coating, or a structural consolidation material used in grouting or anchoring, or a material used in underground constructions.

In a still further aspect, the invention relates to the use of the composition or the mixture according to the invention in flooring, coating, roofing, screed, primer, wall paint, waterproofing, grouting, anchoring and underground constructions.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the term “about” is understood to refer to a range of numbers that a person of skill in the art would consider equivalent to the recited value in the context of achieving the same function or result.

As used herein, the term “methylene malonate” refers to a compound having the core formula —O—C(O)—C(═CH₂)—C(O)—O—.

As used herein, the term “RH” is equal to “Relative Humidity” and refers to the ratio of the partial vapor pressure of water to the saturated vapor pressure of water at a given temperature.

As used herein, the term “substantially absence” as in “substantially absence of the solvent” refers to a reaction mixture which comprises less than 1% by weight of the particular component as compared to the total reaction mixture. In certain embodiments, the “substantial absence” refers to less than 0.7%, less than 0.5%, less than 0.4%, less than 0.3%, less than 0.2% or less than 0.1% by weight of the particular component as compared to the total reaction mixture. In certain other embodiments, the “substantial absence” refers to less than 1.0%, less than 0.7%, less than 0.5%, less than 0.4%, less than 0.3%, less than 0.2% or less than 0.1% by volume of the particular component as compared to the total reaction mixture.

As used herein, the term “stabilized,” e.g., in the context of “stabilized” monomers of the invention or compositions comprising the same, refers to the tendency of the monomers of the invention (or their compositions) to substantially not polymerize with time, to substantially not harden, form a gel, thicken, or otherwise increase in viscosity with time, and/or to substantially show minimal loss in cure speed (i.e., cure speed is maintained) with time as compared to similar compositions that are not stabilized.

As used herein, the term “shelf-life,” e.g., as in the context of the compositions of the invention having an improved “shelf-life,” refers to the compositions of the invention which are stabilized for a given period of time, e.g., 1 month, 6 months, or even 1 year or more.

As used herein, the term “additives” refers to additives included in a formulated system to enhance physical or chemical properties thereof and to provide a desired result. Such additives include, but are not limited to, dyes, pigments, toughening agents, impact modifiers, rheology modifiers, plasticizing agents, thixotropic agents, natural or synthetic rubbers, filler agents, reinforcing agents, thickening agents, opacifiers, inhibitors, fluorescence or other markers, thermal degradation reducers, thermal resistance conferring agents, defoaming agents, surfactants, wetting agents, dispersants, flow or slip aids, biocides, and stabilizers.

As used herein, the term “halogen atom”, “halogen”, “halo-” or “Hal-” is to be understood as meaning a fluorine, chlorine, bromine or iodine atom.

As used herein, the term “alkyl”, either on its own or else in combination with further terms, for example haloalkyl, is understood as meaning a radical of a saturated aliphatic hydrocarbon group and may be branched or unbranched, for example methyl, ethyl, propyl, butyl, isobutyl, pentyl, hexyl, heptyl, octyl, nonyl, decyl, undecyl or dodecyl, or an isomer thereof.

As used herein, the term “alkenyl”, either on its own or else in combination with further terms, for example haloalkenyl, is understood as meaning a straight-chain or branched radical which has at least one double bond, for example vinyl, allyl, propenyl, butenyl, butadienyl, pentenyl, pentadienyl, hexenyl, or hexadienyl, or an isomer thereof.

As used herein, the term “alkynyl”, either on its own or else in combination with further terms, for example haloalkynyl, is understood as meaning a straight-chain or branched radical which has at least one triple bond, for example ethynyl, propynyl, or propargyl, or an isomer thereof.

As used herein, the term “cycloalkyl”, either on its own or else in combination with further terms, is understood as meaning a fused or non-fused, saturated, monocyclic or polycyclic hydrocarbon ring, for example cyclopropyl, cyclobutyl, cyclopentyl, cyclohexyl, cycloheptyl, or cyclooctyl, or an isomer thereof.

As used herein, the term “alkoxy”, either on its own or else in combination with further terms, for example haloalkoxy, is understood as meaning linear or branched, saturated, group having a formula —O-alkyl, in which the term “alkyl” is as defined above, for example methoxy, ethoxy, propoxy, butoxy, pentoxy, or hexoxy, or an isomer thereof.

As used herein, the term “aryl”, either on its own or else in combination with further terms, for example arylalkyl, is understood to include fused or non-fused aryl, such as phenyl or naphthyl, wherein phenyl is optionally substituted by 1 to 5 groups, and naphtyl is optionally substituted by 1 to 7 groups.

As used herein, the term “hetero-” is understood as meaning a saturated or unsaturated radical which is interrupted by at least one heteroatom selected from the group consisting of oxygen (O), nitrogen (N), and sulphur (S).

As used herein, the term “A- to B-member hetero-”, for example “3- to 6-member hetero-”, is understood as meaning a fused or non-fused, saturated or unsaturated monocyclic or polycyclic radical comprising, in addition to carbon atom, at least one heteroatom selected from the group consisting of oxygen (O), nitrogen (N), and sulphur (S), provided that the sum of the number of carbon atom and the number of heteroatom is within the range of A to B. The hetero groups according to this invention are preferably 5- to 30-member hetero groups, most preferably 6- to 18-member hetero groups, especially 6- to 12-member hetero groups, and particularly 6-to 8-member hetero groups.

As used herein, the term “heterocyclyl” is understood as including aliphatic or aromatic heterocyclyl, for example heterocyclylalkyl or heterocyclylalkenyl.

The term “substituted” means that one or more hydrogens on the designated atom is replaced with a selection from the indicated group, provided that the designated atom's normal valency under the existing circumstances is not exceeded, and that the substitution results in a stable compound. Combinations of substituents and/or variables are permissible only if such combinations result in stable compounds.

The term “optionally substituted” means optional substitution with the specified groups, radicals or moieties. Unless stated otherwise, optionally substituted radicals may be mono- or polysubstituted, where the substituents in the case of polysubstitu-tion may be the same or different.

As used herein, halogen-substituted radicals, for example haloalkyl, are mono- or polyhalogenated, up to the maximum number of possible substituents. In the case of polyhalogenation, the halogen atoms can be identical or different. In this case, halogen is fluorine, chlorine, bromine or iodine.

As used herein, the groups with suffix “-ene” represent the groups have two covalent bond which could be linked to other radicals, for example —CH₂CH(CH₃)CH₂-(isobutylene),

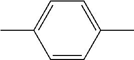

(phenylene), and in the case of phenylene, the covalent bond may be located in ortho-, meta-, or para-position.

As used herein, the term “surface protection” as in “surface protection material” refers to materials applied to the surface of an object or a substrate and generally form a layer for the main purpose of protecting the substrate. The term “protection” used herein may refer to a wide range of activities of protective nature, such as sealing, waterproofing or damp proofing, coating, painting, anti-corrosion, fireproofing, insulating, and antimicrobial etc. If the substrate is a floor, the surface protection is understood as flooring. If the substrate is a roof, the surface protection is understood as roofing.

As used herein, the term “structural consolidation” as in “structural consolidation material” refers to materials applied to parts of an object or a structure, by means of e.g. injection, for the main purpose of increasing the strength or stability of the structure. The term “consolidation” used herein refers to a wide range of activities of consolidating nature, such as reinforcement, connecting various sections into one unit, filling voids or large spaces, sealing joints, bonding steel to masonry etc. If the structural consolidation material is flowable, it's understood as grouting.

As used herein, the term “underground construction” refers to various construction activities performed in sub-surface locations. Exemplary underground constructions are mines, wells, tunnels, subways, basements and the like.

Unless otherwise identified, all percentages (%) are “percent by weight”.

The radical definitions or elucidations given above in general terms or within areas of preference apply to the end products and correspondingly to the starting materials and intermediates. These radical definitions can be combined with one another as desired, i.e. including combinations between the general definition and/or the respective ranges of preference and/or the embodiments.

Unless otherwise identified, the temperature refers to room temperature and the pressure refers to ambient pressure.

Unless otherwise identified, the solvent refers to all organic and inorganic solvents known to the persons skilled in the art, including water, and does not include any type of monomer molecule.

In one aspect, the invention provides a composition comprising:

(A) at least one methylene malonate monomer;

(B) at least one methylene malonate polymer;

(C) at least one acidic stabilizer; and

(D) cement.

Particularly, the composition comprising:

(A) at least one methylene malonate monomer having formula (I),

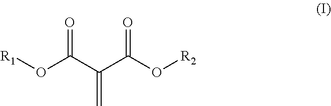

wherein R₁ and R₂ are in each case independently selected from the group consisting of C1-C30-alkyl, C2-C30-alkenyl, C3-C30-cyclolalkyl, C2-C30-heterocyclyl, C2-C30-heterocyclyl-C1-C30-alkyl, C6-C30-aryl, C6-C30-aryl-(C1-C30-alkyl), C2-C30-heteroaryl, C2-C30-heteroaryl-C1-C30-alkyl, C1-C30-alkoxy-C1-C30-alkyl, halo-C1-C30-alkyl, halo-C2-C30-alkenyl, and halo-C3-C30-cyclolalkyl, each of which radicals is optionally substituted, the heteroatom being selected from N, O and S;

(B) at least one methylene malonate polymer having formula (II),

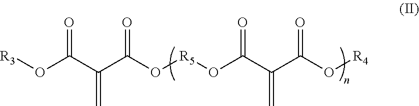

wherein, C1-C30-alkyl, C2-C30-alkenyl, C3-C30-cyclolalkyl, C2-C30-heterocyclyl, C2-C30-heterocyclyl-C1-C30-alkyl, C6-C30-aryl, C6-C30-aryl-(C1-C30-alkyl), C2-C30-heteroaryl, C2-C30-heteroaryl-C1-C30-alkyl, C1-C30-alkoxy-C1-C30-alkyl, halo-C1-C30-alkyl, halo-C2-C30-alkenyl, and halo-C3-C30-cyclolalkyl, each of which radicals is optionally substituted, the heteroatom being selected from N, O and S;

n is an integer from 1 to 20;

R₅, if n=1 is, or if n >1 are in each case independently, selected from the group consisting of C1-C30-alkylene, C2-C30-alkenylene, C2-C30-alkynylene, C6-C30-arylene, C3-C30-cyclolalkylene, C5-C30-cyclolalkenylene, C5-C30-cyclolalkynylene, C2-C30-heterocyclylene, and C2-C30-heteroarylene, each of which radicals is optionally substituted, and the heteroatom being selected from N, O and S, wherein R₅ is optionally interrupted by a radical selected from N, O and S;

(C) at least one acidic stabilizer; and

(D) cement;

wherein, the monomer (A) is in an amount of from 0 to 70 wt. % based on the total weight of the monomer (A) and the polymer (B);

the acidic stabilizer (C) is in an amount of from 0.1 to 500 ppm, preferably from 0.1 to 300 ppm and more preferably from 0.1 to 200 ppm, and most preferably from 0.1 to 100 ppm;

and

cement (D) is in an amount of from 1% to 70 wt. % based on the total weight of the composition.

In a preferred embodiment of the invention, R₁ and R₂ are in each case independently selected from the group consisting of C1-C10-alkyl, C2-C10-alkenyl, C3-C10-cyclolalkyl, C2-C10-heterocyclyl, C2-C10-heterocyclyl-C1-C10-alkyl, C6-C18-aryl, C6-C18-aryl-C1-C10-alkyl, C2-C10-heteroaryl, C2-C10-heteroaryl-C1-C10-alkyl, C1-C10-alkoxy-C1-C10-alkyl, halo-C1-C10-alkyl, halo-C2-C15-alkenyl and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S.

Preferably, R₁ and R₂ are in each case independently selected from the group consisting of C1-C6-alkyl, C2-C6-alkenyl, C3-C6-cyclolalkyl, C3-C6-heterocyclyl, C3-C6-heterocyclyl-C1-C6-alkyl, C6-C8-aryl, C6-C8-aryl-C1-C6-alkyl, C2-C8-heteroaryl, C2-C8-heteroaryl-C1-C6-alkyl, C1-C6-alkoxy-C1-C6-alkyl, halo-C1-C6-alkyl, halo-C2-C6-alkenyl, and halo-C3-C6-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C2-C8-heteroaryl, C3-C6-cyclolalkenyl, and C3-C6-cyclolalkynyl, the heteroatom being selected from N, O and S.

More preferably, R₁ and R₂ are in each case independently selected from the group consisting of C1-C6-alkyl and C3-C6-cyclolalkyl, for example methyl, ethyl, n- or isopropyl, n-, iso-, tert- or 2-butyl, pentyls such as n-pentyl and isopentyl, hexyls such as n-hexyl, isohexyl and 1,3-dimethylbutyl, cyclopropyl, cyclobutyl, cyclopentyl, cyclohexyl.

More preferably, R₁ and R₂ are in each case independently selected from the group consisting of linear C1-C6-alkyl and C3-C6-cyclolalkyl, for example methyl, ethyl, n-propyl, n-butyl, n-pentyl, n-hexyl, cyclohexyl.

In a preferred embodiment of the invention, R₃ and R₄ are in each case independently selected from the group consisting of C1-C10-alkyl, C2-C10-alkenyl, C3-C10-cyclolalkyl, C2-C10-heterocyclyl, C2-C10-heterocyclyl-C1-C10-alkyl, C6-C10-aryl, C6-C10-aryl-C1-C10-alkyl, C2-C10-heteroaryl, C2-C10-heteroaryl-C1-C10-alkyl, C1-C10-alkoxy-C1-C10-alkyl, halo-C1-C10-alkyl, halo-C2-C10-alkenyl, and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S.

Preferably, R₃ and R₄ are in each case independently selected from the group consisting of C1-C6-alkyl, C2-C6-alkenyl, C3-C6-cyclolalkyl, C3-C6-heterocyclyl, C33-C6-heterocyclyl-C1-C6-alkyl, C6-C8-aryl, C6-C8-aryl-C1-C6-alkyl, C3-C6-heteroaryl, C3-C6-heteroaryl-C1-C6-alkyl, C1-C6-alkoxy-C1-C6-alkyl, halo-C1-C6-alkyl, halo-C2-C6-alkenyl, and halo-C3-C6-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, the heteroatom being selected from N, O and S.

More preferably, R₃ and R₄ are in each case independently selected from the group consisting of C1-C6-alkyl, for example methyl, ethyl, n- or isopropyl, n-, iso-, tert- or 2-butyl, pentyls such as n-pentyl and isopentyl, hexyls such as n-hexyl, isohexyl and 1,3-dimethylbutyl.

More preferably, R₃ and R₄ are in each case independently selected from the group consisting of linear C1-C6-alkyl, for example methyl, ethyl, n-propyl, n-butyl, n-pentyl, n-hexyl.

In a preferred embodiment of the invention, R₁, R₂, R₃ and R₄ are the same.

In a preferred embodiment of the invention, n is from 1 to 15, preferably from 1 to 10, more preferably from 1 to 8.

In a preferred embodiment of the invention, R₅, if n=1 is, or if n >1 are in each case independently, selected from the group consisting of C1-C10-alkylene, C2-C10-alkenylene, C2-C10-alkynylene, C3-C18-arylene, C3-C10-cyclolalkylene, C3-C10-cyclolalkenylene, C3-C10-cyclolalkynylene, C2-C10-heterocyclylene, and C2-C10-heteroarylene, each of which radicals is optionally substituted, the heteroatom being selected from N, O and S, wherein R₅ is optionally interrupted by a radical selected from N, O and S.

Preferably, R₅, if n=1 is, or if n >1 are in each case independently, selected from the group consisting of C1-C6-alkylene, C2-C6-alkenylene, C2-C6-alkynylene, C6-C8-arylene, C3-C6-cyclolalkylene, C5-C6-cyclolalkenylene, C5-C6-cyclolalkynylene, C2-C6-heterocyclylene, and C3-C6-heteroarylene, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkyny, the heteroatom being selected from N, O and S, wherein R₅ is optionally interrupted by a radical selected from N, O and S.

More preferably, R₅, if n=1 is, or if n >1 are in each case independently, selected from the group consisting of C1-C6-alkylene and C6-C8-arylene, each of which radicals is optionally substituted by at least one C1-C6-alkyl.

Most preferably, R₅, if n=1 is, or if n >1 are in each case independently, selected from the group consisting of propylidene, pentylidene and phenylene, each of which radicals is optionally substituted by methyl.

Particularly, R₅ may be phenylene. It can be linked to other radicals in the main chain in its ortho-, meta-, or para-position, preferably para-position, i.e.

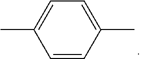

In a preferred embodiment of the invention, the radicals may be further substituted by substituents. Possible substituents may be selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C3-C18-aryl, C3-C18-aryl-C1-C10-alkyl, C2-C10-heteroaryl, C3-C10-cyclolalkenyl, and C3-C10-cyclolalkynyl, wherein the heteroatom is selected from N, O and S.

Preferably, the substituents may be selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C3-C6-heterocyclyl, C3-C6-heterocyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, wherein the heteroatom is selected from N, O and S.

In each case, the compositions of the invention shall include one or more compounds to extend the shelf-life. In certain embodiments, the compositions are formulated such that the composition is stable for at least 6 months and preferably, is stable for at least one year. Said compounds comprise acidic stabilizer.

The present invention contemplates any suitable acidic stabilizer known in the art, including, for example, sulfuric acid (H₂SO₄), trifluoromethane sulfonic acid (TFA), chlorodifluoro acid, maleic acid, methane sulfonic acid (MSA), p-toluenesulfonic acid (p-TSA), difluoro acetic acid, trichloroacetic acid, phosphoric acid, dichloroacetic acid or similar acid. Not being limited by the list, acidic stabilizers can include any material that can be added to the compositions containing monomers or polymers to extend shelf-life by up to, for example, 1 year or more. Such acidic stabilizers may have a pKa in the range of, for example, between about −15 to about 5, or between about −15 to about 3, or between about −15 to about 1, or between about −2 to about 2, or between about 2 to about 5, or between about 3 to about 5.

For each of these acidic stabilizing materials, such acidic stabilizer can be present in an amount of from 0.1 to 500 ppm, preferably from 0.1 to 400, more preferably from 0.1 to 300 ppm, much more preferably from 0.1 to 200 ppm, and much more preferably from 0.1 to 100 ppm.

According to a preferred embodiment of the invention, the cement optionally comprises lime, including hydrated lime and quicklime, and may optionally comprise aggregates, fillers and other additives.

The cement may be a Portland cement, a calcium aluminate cement, a magnesium phosphate cement, a magnesium potassium phosphate cement, a calcium sulfoalumi-nate cement or any other suitable cement known to people in the art. Aggregate may be included in the cement. The aggregate can be silica, quartz, sand, crushed marble, glass spheres, granite, limestone, calcite, feldspar, alluvial sands, any other durable aggregates, and mixtures thereof. Inert fillers and/or further additives may additional-ly be present in the cement component according to the invention. These optional components can alternatively also be added only on preparation of a mortar or concrete.

Generally known gravels, sands and/or powders, for example based on quartz, limestone, barite or clay, in particular quartz sand, are suitable as inert fillers. Light fillers, such as perlite, kieselguhr (diatomaceous earth), exfoliated mica (vermiculite) and foamed sand, can also be used.

Suitable additives are, for example, generally known flow agents, antifoams, water retention agents, plasticizers, pigments, fibers, dispersion powders, wetting agents, retardants, accelerators, complexing agents, aqueous dispersions, rheology modifiers or mixtures thereof.

Surprisingly, it has been found by the inventors that a suitable amount of the monomer, the polymer and cement or of the respective components in the composition leads to an excellent balance of the properties desired by a construction material used in fast constructions and constructions in wet conditions, such as safety, curing speed, early strength, chemical resistance, bonding strength, tensile strength, elongation, and waterproof, and the like. The amounts of the monomer, the polymer and cement or of the respective components in the composition can be adjusted to accommodate different applications, making the methylene malonate cementitious hybrid system a robust product.

According to a preferred embodiment of the invention, the methylene malonate monomer (A) is in an amount of from 0 to 40 wt. % based on the total weight of the monomer (A) and the polymer (B), and the cement is in an amount of from 1 to 30 wt. %, preferably from 5% to 25 wt. % based on the total weight of the composition.

According to an alternative preferred embodiment of the invention, the methylene malonate monomer (A) is in an amount of from 0 to 70 wt. % based on the total weight of the monomer (A) and the polymer (B), and the cement is in an amount of from 30 to 70 wt. %, preferably from 35 to 65 wt. %, based on the total weight of the composition.

According to an embodiment of the invention, the mixture comprises the composition according to the invention.

According to an embodiment of the invention, the mixture comprising the composition according to the invention is substantially absent of any solvent.

According to an embodiment of the invention, the mixture comprising the composition according to the invention may further comprise other additives.

In certain embodiments of the invention, the other additives may be at least one selected from plasticizers, thixotropic agents, adhesion promoters, antioxidants, light stabilizers, UV stabilizer, filler, alkali accelerator, lime stone, surfactant, wetting agents, viscosity modifier, extenders, dispersants, anti-blocking agents, air release agents, anti-sagging agents, anti-setting agents, matting agents, flattening agents, waxes, anti-mar additives, anti-scratch additives, defoaming agent, or inert resins. In a preferred embodiment of the invention, the additives may be at least one selected from plasticizers, thixotropic agents, adhesion promoters, antioxidants, light stabilizers, UV stabilizer, filler, hydraulic binder, lime stone, surfactant, wetting agents, viscosity modifier, dispersants, air release agents, anti-sagging agents, anti-setting agents, defoaming agent, coloring agent, fiber, polymer powder, mesh, chip, hollow spheres and inert resins

In a preferred embodiment, alkali accelerator is in a form of a base, a base precursor, or a base enhancer. As used herein, the term “base” refers to a component having at least one electronegative group capable of initiating anionic polymerization. As used herein, the term “base precursor” refers to a component that may be converted to a base upon being acted upon in some manner, e.g., application of heat, chemical reaction, or UV activation. As used herein, the term “base enhancer” refers to an agent that is capable of acting in some manner to improve or enhance the basicity of an agent.

Preferably, the alkali accelerator is at least one selected from metallic oxide, metallic hydroxide, amine, guanidine, amide, piperidine, piperazine, morpholine, pyridine, hal-ides, salts of metal, ammonium, amine, wherein the anions in said salts is at least one selected from halogens, acetates, chloracetates, benzoates, aliphatic acids, alkene carbox-ylic acids, sulfurs, carbonates, silicates, diketones, monocarboxylic acids, polymers containing carboxylic acids.

For those skilled in the art, the above additives are commercially available. The above formulation additives, if any, are presented in an amount commonly used in the art.

In other embodiments of the invention, the mixture comprising the composition according to the invention may further include a coloring agent, including, but not limited to, organic pigment, organo-metallic pigment, mineral-based pigment, carbon pigments, titanium pigment, azo compound, quinacridone compound, phthalocyanine compound, cadmium pigment, chromium pigment, cobalt pigment, copper pigment, iron pigment, clay earth pigment, lead pigment, mercury pigment, titanium pigment, aluminum pigment, manganese pigment, ultramarine pigment, zinc pigment, arsenic pigment, tin pigment, iron oxide pigment, antimonypigment, barium pigment, a biological pigment, dye, photochromic, conductive and liquid crystal polymer pigment, piezochromic pigment, goniochromaticpigment, silver pigment, diketopyrrolo-pyrrole, benzimidazolone, isoindoline, isoindolinone, radio-opacifier and the like.

For those skilled in the art, the above coloring agents are commercially available. The above coloring agents, if any, are presented in an amount commonly used in the art.

The definitions and description concerning the composition also apply to the process and use of the present invention.

The composition according to the invention may be obtained by a process comprising steps of:

(1) mixing the monomer (A), the polymer (B) and the acidic stabilizer (C); and

(2) mixing the cement (D) with the mixture obtained in step (1) to obtain the composition.

In a preferred embodiment, the process for preparing the composition according to the invention comprises a) mixing the monomer (A) and the polymer (B); b) adding the acidic stabilizer (C) into the mixture obtained from step (a); and c) adding cement into the mixture obtained from step (b).

The mixing used in the process is carried out by conventional means in the art in a unit suitable for mixing, for example, by stirring or agitating, using a mixing stick, a IKA mixer or a magnetic stir bar at a room temperature.

According to specific aspects of the invention, the methylene malonate monomer (A) having formula (I) could be prepared by those skilled in the art by means of the following steps: (a) reacting a malonic acid ester with a source of formaldehyde, optionally in the presence of an acidic or basic catalyst, and optionally in the presence of an acidic or non-acidic solvent, to form a reaction mixture; (b) contacting the reaction mixture or a portion thereof with an energy transfer means to produce a vapor phase comprising methylene malonate monomer; and (c) isolating the methylene malonate monomer from the vapor phase.

According to an embodiment of the invention, the methylene malonate polymer (B) having formula (II) could be prepared by those skilled in the art by means of the following steps: An appropriate amount of starting material (e.g., DEMM) and an appropriate amount of OH-containing linking group (e.g., diol) are mixed and reacted in the presence of a catalyst (e.g., Novazym 435), and the resulting mixture is stirred and heated for a period of time at a certain temperature, while the alcohol generated was removed by evaporation. Subsequently, the reaction mixture is cooled and stabilized with a minor amount of acid stabilizer, and then filtered to obtain the desired product.

In an aspect, the invention relates to the use of the composition or the mixture according to the invention as a construction material.

In a preferred embodiment, the invention relates to the use of the composition or the mixture according to the invention as a surface protection material, such as flooring, roofing, primer, waterproofing, wall paint or coating material.

In another preferred embodiment, the invention relates to the use of the composition or the mixture according to the invention as a structural consolidation material, such as grouting or anchoring material.

Preferably, the composition or the mixture is applied to a substrate or a structure selected from rock, concrete, wood, glass, resin, stone, earth, mud, sand and the like. Even more preferably, the composition or the mixture is applied to a wet surface or to a wet structure. Even more preferably, the composition or the mixture is used under water.

In an alternative embodiment, the invention relates to the use of the composition in underground constructions, including but not limited to, mines, wells, tunnels, subways, basements and the like. Compared to other civil engineering projects that are performed above the ground, underground constructions are performed in a closed or partially closed space with bad ventilation and require fast curing speed and fast strength build-up. The methylene malonate cementitious hybrid system according to the invention has low or substantially no solvent and can cure within a short period of time, making it suitable for underground constructions.

The composition or the mixture is applied by conventional means in the art, such as brushing, spraying, rolling, casting, self-leveling and injecting.

In one embodiment, components (A)-(C) are stored in one package and component (D) is stored in a different package. Said two packages are mixed on the spot for applications of the composition before applying to substrates or structures.

The temperature for the use is from −30° C. to 60° C. and preferably from −20° C. to 40° C. And the relative humidity for the use is from 1% to 99% and preferably from 5% to 95%.

The composition or mixture according to the invention may be applied in a conventional way in the art. In a preferred embodiment, the monomer (A) and the polymer (B) are mixed with the acidic stabilizer (C) and optional additives such as filler and/or UV stabilizer to give a ready-made formulation, and then adding cement (D) into the system and applying the mixture onto the substrates or into structures.

In the present invention, roofing, priming, waterproofing, coating or flooring may be carried out in a way known to those skilled in the art, for example by brushing, spraying, leveling, or roller-coating. In the present invention, grouting or anchoring may be carried out in a way known to those skilled in the art, for example by injecting or casting. It is noted that the specific way of application used in the present invention depends on the workability of the composition. Particularly, injecting requires a relatively longer gel time compared to spraying.

In the embodiments of the present invention, the composition or the mixture can also be used in other civil engineering constructions which requires a fast curing time and strength build-up, a good balance of properties among tensile strength, flexibility, bonding strength, waterproofing, temperature and humidity tolerance.

In a preferred embodiment of the present invention, the composition or the mixture is applied on wet substrates or to wet structures. In an alternative embodiment, the composition or the mixture is used under water.

In the embodiments of the present invention, the temperature for the use is from −30° C. to 60° C. and preferably from −20° C. to 40° C.

In the embodiments of the present invention, the relative humidity for the use is from 1% to 99% and preferably from 5% to 95%.

### Embodiment

The following embodiments are used to illustrate the invention in more detail.

The 1^{st} embodiment is a composition comprising:

(A) at least one methylene malonate monomer having formula (I):

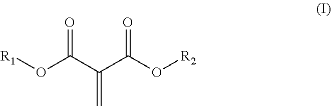

wherein, R₁ and R₂ are in each case independently selected from the group consisting of C1-C30-alkyl, C2-C30-alkenyl and C3-C30-cyclolalkyl;

(B) at least one methylene malonate polymer having formula (II):

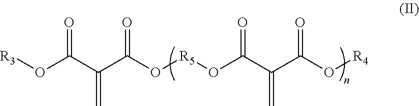

wherein, R₃ and R₄ are in each case independently selected from the group consisting of C1-C30-alkyl, C2-C30-alkenyl and C3-C30-cyclolalkyl;

n is an integer from 1 to 20; and

R₅, if n=1 is, or if n >1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and cement (D),

wherein, the monomer (A) is in an amount of 0 to 40 wt. % based on the total weight of the monomer (A) and the polymer (B), and the acidic stabilizer (C) is in an amount of 0.1 to 500 ppm, and the cement (D) is in an amount of 1 to 30 wt. % based on the total weight of the multi-componenet composition.

The 2^{nd} embodiment is a composition comprising

(A) at least one methylene malonate monomer having formula (I)

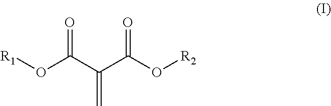

wherein, R₁ and R₂ are in each case independently selected from the group consisting of C2-C30-alkenyl, C2-C30-alkenyl and C3-C30-cyclolalkyl;

(B) at least one methylene malonate polymer having formula (II):

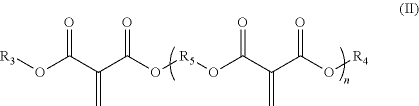

wherein, R₃ and R₄ are in each case independently selected from the group consisting of C1-C30-alkyl, C2-C30-alkenyl and C3-C30-cyclolalkyl;

n is an integer from 1 to 15; and

R₅, if n=1 is, or if n >1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and cement (D),

wherein, the monomer (A) is in an amount of 5 to 35 wt. % based on the total weight of the monomer (A) and the polymer (B), and the acidic stabilizer (C) is in an amount of 0.1 to 400 ppm, and the cement (D) is in an amount of 1 to 30 wt. % based on the total weight of the multi-componenet composition.

The 3^{rd} embodiment is a composition comprising

(A) at least one methylene malonate monomer having formula (I):

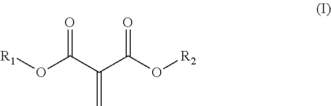

wherein, R₁ and R₂ are in each case independently selected from the group consisting of C2-C30-alkenyl, C2-C30-alkenyl and C3-C30-cyclolalkyl;

(B) at least one methylene malonate polymer having formula (II):

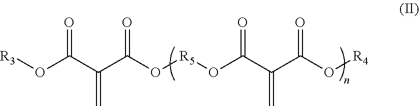

wherein, R₃ and R₄ are in each case independently selected from the group consisting of C1-C30-alkyl, C2-C30-alkenyl and C3-C30-cyclolalkyl;

n is an integer from 1 to 10; and

R₅, if n=1 is, or if n >1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 5 to 35 wt. % based on the total weight of the monomer (A) and the polymer (B), and the acidic stabilizer (C) is in an amount of 0.1 to 300 ppm, and the cement (D) is in an amount of 1 to 25 wt. % based on the total weight of the multi-componenet composition.

The 4^{th} embodiment is a composition comprising

(A) at least one methylene malonate monomer having formula (I)

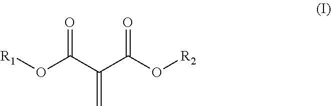

wherein, R₁ and R₂ are in each case independently selected from the group of C6-C30-aryl;

(B) at least one methylene malonate polymer having formula (II):

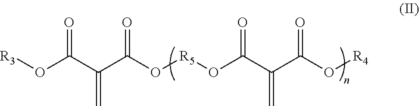

wherein, R₃ and R₄ are in each case independently selected from the group of C1-C30-alkyl,

n is an integer from 1 to 8; and

R₅, if n=1 is, or if n >1 are in each case independently, selected from the group consisting of C1-C30-alkylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 5 to 30 wt. % based on the total weight of the monomer (A) and the polymer (B), and the acidic stabilizer (C) is in an amount of 0.1 to 250 ppm, and the cement (D) is in an amount of 1 to 25 wt. % based on the total weight of the multi-componenet composition.

The 5^{th} embodiment is a composition comprising

(A) at least one methylene malonate monomer having formula (I):

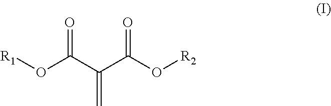

wherein, R₁ and R₂ are in each case independently selected from the group of C1-C30-alkyl,

(B) at least one methylene malonate polymer having formula (II):

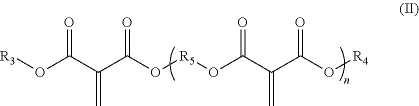

wherein, R₃ and R₄ are in each case independently selected from the group of C1-C30-alkyl;

n is an integer from 1 to 6; and

R₅, if n=1 is, or if n >1 are in each case independently, selected from the group consisting of C1-C30-alkylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 10 to 30 wt. % based on the total weight of the monomer (A) and the polymer (B), and the acidic stabilizer (C) is in an amount of 0.1 to 200 ppm, and the cement (D) is in an amount of 1 to 20 wt. % based on the total weight of the multi-componenet composition.

The 6^{th} embodiment is a composition comprising

(A) at least one methylene malonate monomer having formula (I):

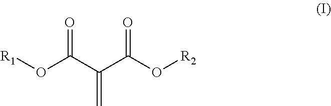

wherein, R₁ and R₂ are in each case independently selected from the group of C1-C30-alkyl;

(B) at least one methylene malonate polymer having formula (II):

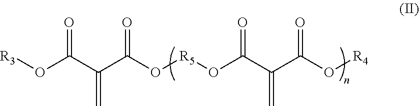

wherein, R₃ and R₄ are in each case independently selected from the group consisting of C1-C30-alkyl,

n is an integer from 1 to 6; and

R₅, if n=1 is, or if n >1 are in each case independently, selected from the group consisting of C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 15 to 20 wt. % based on the total weight of the monomer (A) and the polymer (B), and the acidic stabilizer (C) is in an amount of 0.1 to 180 ppm, and the cement (D) is in an amount of 1 to 15 wt. % based on the total weight of the multi-componenet composition.

The 7^{th} embodiment is a composition comprising

(A) at least one methylene malonate monomer having formula (I):

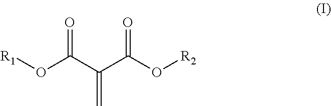

wherein, R₁ and R₂ are in each case independently selected from the group consisting of C1-C30-alkyl, C2-C30-alkenyl and C3-C30-cyclolalkyl

(B) at least one methylene malonate polymer having formula (II):

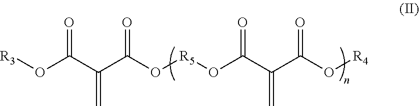

wherein, R₃ and R₄ are in each case independently selected from the group consisting of C1-C30-alkyl, C2-C30-alkenyl and C3-C30-cyclolalkyl

n is an integer from 1 to 8; and

R₅, if n=1 is, or if n >1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 0 to 70 wt. %, and the acidic stabilizer (C) is in an amount of 0.1 to 500 ppm, and the cement (D) is in an amount of 30 to 70 wt. % based on the total weight of the multi-componenet composition.

The 8^{th} embodiment is a composition comprising

(A) at least one methylene malonate monomer having formula (I):

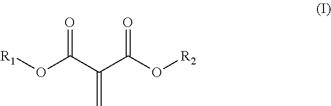

wherein, R₁ and R₂ are in each case independently selected from the group consisting of C1-C30-alkyl, C2-C30-alkenyl and C3-C30-cyclolalkyl

(B) at least one methylene malonate polymer having formula (II):

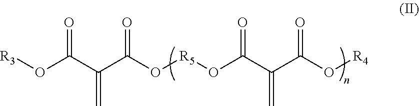

wherein, R₃ and R₄ are in each case independently selected from the group consisting of C1-C30-alkyl, C2-C30-alkenyl and C3-C30-cyclolalkyl

n is an integer from 1 to 10; and

R₅, if n=1 is, or if n >1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 5 to 65 wt. % based on the total weight of the monomer (A) and the polymer (B), and the acidic stabilizer (C) is in an amount of 0.1 to 400 ppm, and the cement (D) is in an amount of 30 to 67 wt. % based on the total weight of the multi-componenet composition.

The 9^{th} embodiment is a composition comprising

(A) at least one methylene malonate monomer having formula (I):

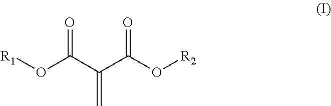

wherein, R₁ and R₂ are in each case independently selected from the group consisting of C1-C30-alkyl, C2-C30-alkenyl and C3-C30-cyclolalkyl

(B) at least one methylene malonate polymer having formula (II):

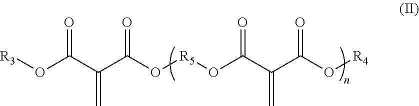

wherein, R₃ and R₄ are in each case independently selected from the group consisting of C1-C30-alkyl, C2-C30-alkenyl and C3-C30-cyclolalkyl n is an integer from 1 to 12; and

R₅, if n=1 is, or if n >1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 10 to 65 wt. % based on the total weight of the monomer (A) and the polymer (B), and the acidic stabilizer (C) is in an amount of 0.1 to 200 ppm, and the cement (D) is in an amount of 35 to 65 wt. % based on the total weight of the multi-componenet composition.

The 10^{th} embodiment is a composition comprising

(A) at least one methylene malonate monomer having formula (I):

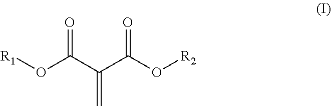

wherein, R₁ and R₂ are in each case independently selected from the group consisting of C1-C30-alkyl, C2-C30-alkenyl and C3-C30-cyclolalkyl

(B) at least one methylene malonate polymer having formula (II):

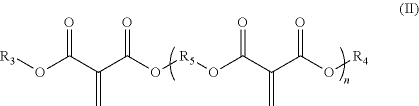

wherein, R₃ and R₄ are in each case independently selected from the group consisting of C1-C30-alkyl, C2-C30-alkenyl and C3-C30-cyclolalkyl

n is an integer from 1 to 15; and

R₅, if n=1 is, or if n >1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 10 to 50 wt. % based on the total weight of the monomer (A) and the polymer (B), and the acidic stabilizer (C) is in an amount of 0.1 to 150 ppm, and the cement (D) is in an amount of 40 to 60 wt. % based on the total weight of the multi-componenet composition.

The 11^{th} embodiment is a composition comprising

(A) at least one methylene malonate monomer having formula (I):

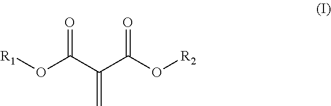

wherein, R₁ and R₂ are in each case independently selected from the group consisting of C1-C30-alkyl, C2-C30-alkenyl and C3-C30-cyclolalkyl

(B) at least one methylene malonate polymer having formula (II):

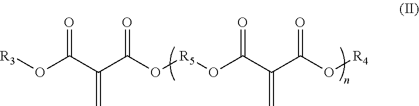

wherein, R₃ and R₄ are in each case independently selected from the group consisting of C1-C30-alkyl, C2-C30-alkenyl and C3-C30-cyclolalkyl

n is an integer from 1 to 20; and

R₅, if n=1 is, or if n >1 are in each case independently, selected from the group consisting of C1-C30-alkylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 10 to 50 wt. % based on the total weight of the monomer (A) and the polymer (B), and the acidic stabilizer (C) is in an amount of 0.1 to 100 ppm, and the cement (D) is in an amount of 35 to 60 wt. % based on the total weight of the multi-componenet composition.

The 12^{th} embodiment is a composition comprising

(A) at least one methylene malonate monomer having formula (I):

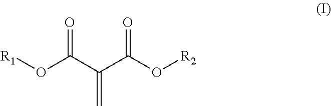

wherein, R₁ and R₂ are in each case independently selected from the group consisting of e C1-C30-alkyl, C2-C30-alkenyl, C3-C30-cycloalkyl, C6-C30-aryl, halo-C1-C30-alkyl;

(B) at least one methylene malonate polymer having formula (II):

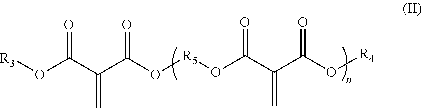

wherein, R₃ and R₄ are in each case independently selected from the group consisting of C1-C30-alkyl, C2-C30-alkenyl, C3-C30-cycloalkyl, C6-C30-aryl, halo-C1-C30-alkyl;

n is an integer from 1 to 6; and

R₅, if n=1 is, or if n >1 are in each case independently, selected from the group of C1-C30-alkylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 30 to 60 wt. % based on the total weight of the monomer (A) and the polymer (B), and the acidic stabilizer (C) is in an amount of 0.1 to 150 ppm, and the cement (D) is in an amount of 35 to 65 wt. % based on the total weight of the multi-componenet composition.

The 13^{th} embodiment is a composition comprising

(A) at least one methylene malonate monomer having formula (I):

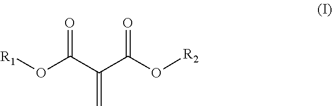

wherein, R₁ and R₂ are in each case independently selected from the group consisting of C1-C30-alkyl, C2-C30-alkenyl, C3-C30-cycloalkyl, C6-C30-aryl, halo-C1-C30-alkyl;

(B) at least one methylene malonate polymer having formula (II):

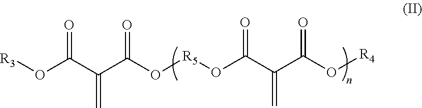

wherein, R₃ and R₄ are in each case independently selected from the group consisting of C1-C30-alkyl, C2-C30-alkenyl, C3-C30-cycloalkyl, C6-C30-aryl, halo-C1-C30-alkyl;

n is an integer from 1 to 8; and

R₅, if n=1 is, or if n >1 are in each case independently, selected from the group of C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 10 to 70 wt. % based on the total weight of the monomer (A) and the polymer (B), and the acidic stabilizer (C) is in an amount of 0.1 to 100 ppm, and the cement (D) is in an amount of 33 to 67 wt. % based on the total weight of the multi-componenet composition.

The 14^{th} embodiment is a composition comprising

(A) at least one methylene malonate monomer having formula (I):

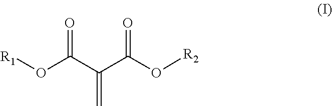

wherein, R₁ and R₂ are in each case independently selected from the group of C1-C30-alkyl;

(B) at least one methylene malonate polymer having formula (II):

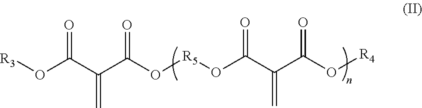

wherein, R₃ and R₄ are in each case independently selected from the group of C1-C30-alkyl;

n is an integer from 1 to 8; and

R₅, if n=1 is, or if n >1 are in each case independently, selected from the group of C6-C30-arylene and C6-C30-arylene; and

(C) at least one selected from trifluoromethane sulfonic acid, chlorodifluoro acid, maleic acid, methane sulfonic acid, difluoroacetic acid, trichloroacetic acid, phosphoric acid, dichloroacetic acid and phenol;

and Cement (D),

wherein, the monomer (A) is in an amount of 40 to 60 wt. % based on the total weight of the monomer (A) and the polymer (B), and the acidic stabilizer (C) is in an amount of 0.1 to 100 ppm, and the cement (D) is in an amount of 35 to 45 wt. % based on the total weight of the multi-componenet composition.

The 15^{th} embodiment is a mixture comprising the composition according to any one of embodiments 1-14 which further comprises one or more additives selected from the group consisting of plasticizers, thixotropic agents, adhesion promoters, antioxidants, light stabilizers, UV stabilizer, filler, alkali accelerator, lime stone, surfactant, wetting agents, viscosity modifier, dispersants, air release agents, anti-sagging agents, anti-setting agents, defoaming agent, coloring agent, fiber, polymer powder, mesh, chip, hollow spheres and inert resins.

The 16^{th} embodiment is a mixture comprising the composition according to any one of embodiments 1-14, which further comprises one or more additives selected from the group consisting of plasticizers, anti-sagging agents, thixotropic agents, surfactant, filler, lime stone, polymer powder and defoaming agent.

The 17^{th} embodiment is a mixture comprising the composition according to any one of embodiments 1-14, which further comprises one or more additives selected from the group consisting of antioxidants, light stabilizers, UV stabilizers and fillers.

The 18^{th} embodiment is a mixture comprising the composition according to any one of embodiments 1-14, which further comprises one or more additives selected from the group consisting of viscosity modifier, adhesion promoters, pigments, air release agents, inert resin and defoaming agent.

The 19^{th} embodiment is a mixture comprising the composition according to any one of embodiments 1-14, which further comprises other additives selected from the group consisting of pigments, dispersants, thixotropic agents, air release agents, fiber and fillers.

The 20^{th} embodiment is a mixture comprising the composition according to any one of embodiments 1-14, which further comprises other additives selected from the group consisting of antioxidants, anti-sagging agents, air release agents, defoaming agent, chip and fillers.

### Example

The present invention will now be described with reference to Examples and Comparative Examples, which are not intended to limit the scope of the present invention.

The following starting materials were used:

Diethyl malonate (DEM), dihexyl malonate (DHM) and dicyclohexyl malonate (DCM) were purchased from Alfa Aesar. Paraformaldehyde, potassium acetate, copper (II) acetate, Novazym 435 as catalyst were purchased from Acros Organics. Maleic acid, 1,5-pentanediol, 2-methylpropane-1,3-diol, 1,4-phenylenedimethanol were purchased from Alfa Aesar. Methane sulfonic acid and sulfuric acid were purchased from Sigma-Aldrich. Trifluoromethanesulfonic acid was purchased from Aladdin. Cement was purchased from Anhui Conch Cement Company Limited (Hailuo 52.5).

Analytical Methods

(1) NMR (Nuclear Magnetic Resonance)

Routine one-dimensional NMR spectroscopy was performed on either a 400 MHz Varian® spectrometer or a 400 MHz Bruker® spectrometer. The samples were dissolved in deuterated solvents. Chemical shifts were recorded on the ppm scale and were referenced to the appropriate solvent signals, such as 2.49 ppm for DMSO-d6, 1.93 ppm for CD₃CN, 3.30 ppm for CD₃OD, 5.32 ppm for CD₂Cl₂ and 7.26 ppm for CDCl₃ for 1H spectra.

(2) GC-MS (Gas Chromatography Mass. Spectrometry)

GC-MS was obtained with a Hewlett Packard 5970 mass spectrometer equipped with Hewlett Packard 5890 Gas Chromatograph. The ion source was maintained at 270° C.

(3) ESI-MS (Electrospray Ionization Mass. Spectrometry)

Electrospray ionization mass spectra were obtained using a Thermo LTQ-FT, a hybrid instrument consisting of a linear ion trap mass analyzer and a Fourier transform ion cyclotron resonance (FT-ICR) mass analyzer.

Measurement Methods

(1)Gel Time

Throughout the present invention, gel time means the time from the start of mixing Component I and Component II of the composition to the composition becoming too viscous and losing the workability. Particularly, short gel time (for example 0.5-5 min) is suitable for spray coating, whereas longer gel time (for example 15-30 min) is needed for roller coating. Gel time is measured according to DIN EN ISO 9514.

(2) Dry Through Time

Throughout the present invention, dry through Time means the time from the start of mixing Component I and Component II of the composition and forming the composition into a layer with certain thickness to said layer becoming completely dry. Dry through time is measured according to ASTM D1640.

(3) Hardness

Throughout the present invention, Shore D hardness is determined according to DIN53505.

Hardness by pencil test is determined according to ISO 15184.

(4) Chemical Resistance

Chemical resistance is measured according to ASTM D1308-02. The test period is ten days.

Preparation Example

I. The Preparation of Monomer (A)

### Example 1: The Preparation of Diethyl Methylenemalonate (DEMM)

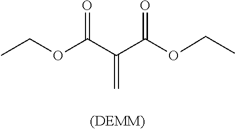

<1>. In a two-liter 3-neck round bottom flask (equipped with a condenser), 60 g of paraformaldehyde (2 mol), 10 g of potassium acetate and 10 g of copper (II) acetate were mixed in 80 ml of tetrahydrofuran (THF).

<2>. This mixture was stirred and heated at 65° C. for 40 min. From an additional funnel, 160 g (1 mol) of diethyl malonate (DEM) was then added dropwise to the reaction mixture.

<3>. At the end of the addition of DEM (about an hour), the reaction mixture was further stirred at 65° C. for 2 hours.

<4>. The reaction mixture was then cooled to room temperature and 10 g of sulfuric acid was added into the flask with stirring.

<5>. The precipitates were then removed by filtration and the filtrate was collected. 0.01 g of sulfuric acid (60 ppm) was added to the collected filtrate.

<6>. The filtrate was then distilled at reduced pressure. Diethyl Methylenemalonate was collected at 55-70° C. with about 1.5 mm Hg of vacuum as the crude monomer.

<7>. The crude monomer (with 60 ppm of sulfuric acid) was further fractionally distilled with stainless steel packed column under reduced vacuum. This gives 141 g (yield of 82%, purity of 98%) pure monomer.

<8>. The monomer was stabilized with 40 ppm of sulfuric acid.

1H-NMR (400 MHz, CDCl₃) δ 6.45 (s, 2H), 4.22 (q, 4H), 1.24 (t, 6H). GC-MS (m/z): 173, 145, 127, 99, 55.

The ion at m/z 173 represents the protonated DEMM.

### Example 2: The Preparation of Dihexyl Methylene Malonate (DHMM)

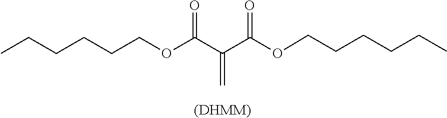

The preparation is carried out according to Example 1, except for using dihexyl malonate in step 2. This gives 227 g (yield of 80%, purity of 95%) pure monomer. The monomer was stabilized with 60 ppm of sulfuric acid.

GC-MS (m/z): 285

### Example 3: The Preparation of Dicyclohexyl Methylene Malonate (DCHMM)

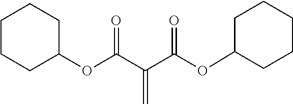 [SMILES: C=C(C(=O)OC1CCCCC1)C(=O)OC1CCCCC1]

The preparation is carried out according to Example 1, except for using dicyclohexyl malonate in step 2. This gives 224 g (yield of 80%, purity of 95%) pure monomer. The monomer was stabilized with 60 ppm of sulfuric acid.

GC-MS (m/z): 281

II. The Preparation of Polymer (B)

### Example 4: The Preparation of Polymer (B-1)

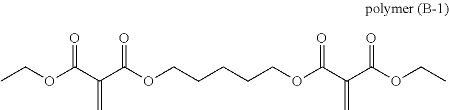 [SMILES: C=C(C(=O)OCC)C(=O)OCCCCCOC(=O)C(=C)C(=O)OCC]

In a round flask (equipped with a condenser), 0.5 g Novazym 435 (catalyst), 17.3 g DEMM (0.1 mol) and 4.2 g 1,5-pentanediol (0.04 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product.

ESI-MS (m/z): 357

### Example 5: The Preparation of Polymer (B-2)

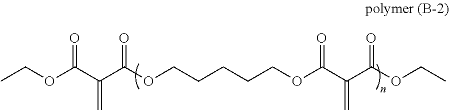

In a round flask (equipped with a condenser), 0.5 g Novazym 435 (catalyst), 17.3 g DEMM (0.1 mol) and 8.3 g 1,5-pentanediol (0.08 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product, wherein n is an integer from 2 to 8.

ESI-MS (m/z): 541 (n=2), 725 (n=3), 909 (n=4), 1093 (n=5), 1277 (n=6), 1461 (n=7), 1645 (n=8).

### Example 6: The Preparation of Polymer (B-3)

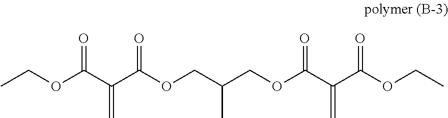 [SMILES: C=C(C(=O)OCC)C(=O)OCC(C)COC(=O)C(=C)C(=O)OCC]

In a round flask (equipped with a condenser), 0.5 g Novazym 435 (catalyst), 17.3 g DEMM (0.1 mol) and 3.6 g 2-methylpropane-1,3-diol (0.04 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product.

ESI-MS (m/z): 343

### Example 7: The Preparation of Polymer (B-4)

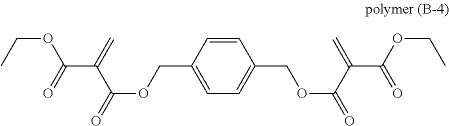 [SMILES: C=C(C(=O)OCC)C(=O)OCc1ccc(COC(=O)C(=C)C(=O)OCC)cc1]

In a round flask (equipped with a condenser), 0.5 g Novazym 435 (catalyst), 17.3 g DEMM (0.1 mol) and 5.52 g 1,4-phenylenedimethanol (0.04 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product.

ESI-MS (m/z): 391

### Example 8: The Preparation of Polymer (B-5)

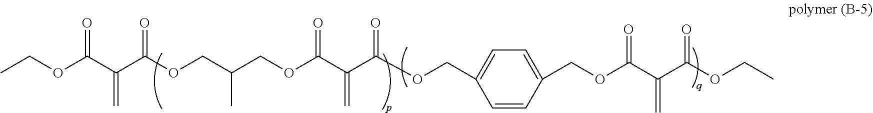

In a round flask (equipped with a condenser), 0.5 g Novazym 435 (catalyst), 17.3 g DEMM (0.1 mol) 3.6 g 2-methylpropane-1,3-diol (0.04 mol) and 5.52 g 1,4-phenylenedimethanol (0.04 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product, wherein the sum of p and q is an integer from 2 to 8.

ESI-MS (m/z): 561 (p=1, q=1), 779 (p=1, q=2), 731 (p=2, q=1), 949 (p=2, q=2), 997 (p=1, q=3), 901 (p=3, q=1), 1215 (p=1, q=4), 1167 (p=2, q=3), 1119 (p=3, q=2), 1071 (p=4, q=1), 1433 (p=1, q=5), 1385 (p=2, q=4), 1337 (p=3, q=3), 1289 (p=4, q=2), 1241 (p=5, q=1)

III. The Preparation and Performance of the Composition

According to the following general procedure, the compositions as per Table 1 were prepared and later applied on the surface of a wet brick by using gauge Mayer rod in each case.

In the respective blending proportions shown in Table 1, the monomer (A) and the polymer (B) were first placed in a plastic vessel with a magnetic stir bar at 25° C. and under atmospheric pressure. While stirring, without heating, at 900 rpm, the acidic stabilizer (C) was added into the vessel. The mixture is continuously stirred for an additional 5 minutes. Then, cement (D) was added to the mixture and stirred to form the composition.

TABLE 1
The components of the compositions in Example 9-15

| | | | | | | | | Comparative |
|---|---|---|---|---|---|---|---|---|
| Composition | | Inventive composition | | | | | | composition |
| Example | | 9 | 10 | 11 | 12 | 13 | 14 | 15 |
| (A): | DEMM | — | — | 40 | 40 | — | — | — |
| Monomer | DCHMM | — | — | — | — | 70 | 10 | 100 |
| (wt %)* | | | | | | | | |
| (B): | Polymer | 44 | 44 | 26 | 26 | 13 | 40 | — |
| Polymer | (B-1) | | | | | | | |
| (wt %) * | Polymer | 56 | 56 | 34 | 34 | 17 | 50 | — |
| | (B-2) | | | | | | | |
| (C): | (C)-1 MSA | 30 | 30 | 38 | 38 | 21 | 29 | 17.5 |
| Acidic | (C)-2 | 10 | 10 | 6 | 6 | 12 | 10 | 12.5 |
| Stabilizer | H₂SO₄ | | | | | | | |
| (ppm) | (C)-3 TEA | 3 | 3 | 27 | 27 | 3 | 3 | 3 |

| | | | | | | | |
|---|---|---|---|---|---|---|---|
| (D): Cement (wt %)** | 5 | 29 | 29 | 33 | 67 | 67 | 67 |

*based on the total weight of monomer (A) and polymer (B)
**based on the total weight of the composition

MasterTop P1601 commercially available from BASF is a multi-component epoxy resin primer for flooring and waterproofing systems and is used as Comparative Example 16.

Gel time of the compositions were tested. The results are shown in the following Table 2.

The composition was applied onto the surface of a wet brick, and then a 2.5 gauge Mayer rod was used to drag the composition down on the wet brick resulting in a film with 0.2 mm thickness for hardness and chemical resistance test. The dry through time of said films obtained were tested. The results are also shown in the following Table 2.

TABLE 2
Gel time and dry through time of the compositions

| Example | 9 | 11 | 12 | 13 | 15 | 16 |
|---|---|---|---|---|---|---|
| Gel time (min) | 60 | 30 | 15 | 10 | 3 | 60 |
| Dry through Time | 2.5 | 2 | 1.2 | 1 | 0.2 | 7 |
| (hour) | | | | | | |

It is advantageous that the compositions according to the invention have a wide range of gel time, i.e. workability, and can be adjusted to accommodate the requirements of different applications. For surface protective applications such as primer, flooring, roofing, waterproofing etc., it is acceptable that such surface protection materials have a gel time of no less than 20 min and a dry through time of less than 8 hours. A composition with a relatively long gel time, eg. between 20-120 min, can be applied to the substrate by brushing, self-levelling or rolling. For structural consolidation applications, underground constructions or civil engineering that require fast curing, a shorter gel time is preferred, eg. between 0.5-20 min. A composition with a relatively short gel time and good flowability can be applied to the structure by spraying, injecting or casting. From the above, it shows that the samples of Inventive Examples exhibit fast and controlled curing, thus are suitable for use in various constructions.

Base resistance and hardness by pencil test of Inventive Compositions and Comparative Composition 16 were tested and the results are shown in Table 3 below.

TABLE 3
Base resistance and hardness by pencil test of the compositions

| | | Composition | | |
|---|---|---|---|---|
| | | | | Comparative |
| | | Inventive Composition | | Composition |
| Example | | 9 | 11 | 16 |
| Base resistance | | no damage | no damage | no damage |
| (10 wt. % NaOH) | | after 10 days | after 10 days | after 10 days |
| Hardness by | After 3 hours** | 5B | 5B | * |
| pencil test | After 24 hours | HB | B | 5B |

* Too low to be measured
**Starting from mixing all components of the composition. The same time measurement is used hereinafter.

It shows that the composition of Example 9 and Example 11 both have good resistance against common basic solvent.

The hardness by pencil test of Example 9 and Example 11 shows much faster curing speed and much stronger early strength compared to that of Comparative Example 16. After 3 hours, both Example 9 and Example 11 reach the hardness of Comparative Example 16 after 24 hours. It is advantageous that the compositions of the invention can achieve good hardness after sufficient curing, i.e. the hardness (by pencil test) of the compositions according to Example 9 and 11 after 24 hours is better than HB.

The curing profile of Example 12-13 and Comparative Example 15 is characterized by recording their Shore D hardness development with time. The results are summarized in Table 4 below.

TABLE 4
Hardness of the compositions in Example 12-13 and
Comparative Example 15

| | | Composition | | |
|---|---|---|---|---|
| | | Inventive | | Comparative |
| | | Composition | | Composition |
| Example | | 12 | 13 | 15 |
| Hardness | After 2 hours | 54 | 50 | 15 |
| (Shore D) | After 3 hours | 62 | 58 | 30 |
| | After 24 hours | 72 | 71 | 60 |

It is advantageous that the compositions of the invention can achieve good hardness after sufficient curing, i.e. the Shore D hardness of the compositions according to Example 12 and 13 after 24 hours is no less than 70. Moreover, the inventive compositions can also cure at a fast speed, i.e. the compositions have satisfactory early harness after several hours of curing. The above results indicate that the composition's Shore D hardness after 3 hours is no less than 80% of its Shore D hardness after 24 hours. Such curing profile makes the compositions suitable for use as structural consolidation materials or for use in civil engineering that requires fast curing, such as underground constructions.

The tensile strength and elongation rate of Inventive Composition is summarized in Table 5 below.

TABLE 5
Tensile Strength and Elongation Rate of the
compositions in Example 13-14

| | Composition | |
|---|---|---|
| | Inventive Composition | |
| Example | 13 | 14 |
| Tensile Strength (MPa) | 10.41 | 11.12 |
| Elongation Rate (%) | 0.891 | 1.23 |

It is advantageous that the inventive composition has a good elongation rate of no less than 1.5% and a good tensile strength of no less than 7 Mpa, showing excellent flexibility and mechanical properties. Elongation and Tensile Strength are each determined according to DIN 53504.

### Example 17: Curing Under Water

According to the same respective blending proportion of Example 13 shown in Table 1 and the same preparation method, the composition comprising components (A)-(D) was prepared and applied onto the surface of a wet brick, and then a 2.5 gauge Mayer rod was used to drag the composition down on the wet brick resulting in a film with 0.2 mm thickness. The brick and the film coating thereon were then immersed under water to test the curing performance. The brick and the film coating were taken out from time to time to measure the hardness development.

TABLE 6
Curing performance under water

| Example | | 17 |
|---|---|---|
| Gel time (min) | | 10 |
| Dry through Time (hour) | | A film was formed on the interface of water |
| | | and composition when the composition and |
| | | water were immersed under water |
| Hardness | After 2 hours | 52 |
| (Shore D) | After 3 hours | 59 |
| | After 24 hours | 73 |

Example 17 shows a similar curing behavior compared to Example 13, including gel time and Shore D hardness development, which indicates that the composition according to this invention has no difficulty curing under water.

### Example 18: Curing at Low Temperature

According to the same respective blending proportion of Example 13 shown in Table 1 and the same preparation method except that the preparation of composition, brick and the film was carried out at 5° C., the composition comprising components (A)-(D) was prepared and applied onto the surface of a wet brick, and then a 2.5 gauge Mayer rod was used to drag the composition down on the wet brick resulting in a film with 0.2 mm thickness. The curing performance at low temperature was then tested.

TABLE 7
Curing performance at 5° C., 50% RH

| | Composition | |
|---|---|---|
| | Inventive | Comparative |
| | Composition | Composition |
| Example | 18 | 16 |
| Gel time (min) at 5° C. | 20 | * |
| Dry through Time (hour) at 5° C. | 0.5 | * |
| Hardness (Shore D) after 2 hours | 10 | * |
| Hardness (Shore D) after 3 hours | 20 | * |
| Hardness (Shore D) after 24 hours | 56 | * |

* fail to cure because of crystallization in low temperature

From the above, it shows that the composition of this invention exhibits fast and controlled curing, even at low temperature.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1. A composition comprising:
(A) at least one methylene malonate monomer;
(B) at least one methylene malonate polymer;
(C) at least one acidic stabilizer; and
(D) cement.

2. The composition according to claim 1, wherein the methylene malonate monomer (A) has formula (I), 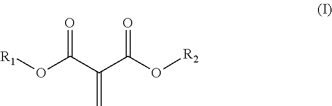
wherein, R₁ and R₂ are in each case independently selected from the group consisting of C1-C30-alkyl, C2-C30-alkenyl, C3-C30-cyclolalkyl, C2-C30-heterocyclyl, C2-C30-heterocyclyl-(C1-C30-alkyl), C6-C30-aryl, C6-C30-aryl-C1-C30-alkyl, C2-C30-heteroaryl, C2-C30-heteroaryl-C1-C30-alkyl, C1-C30-alkoxy-C1-C30-alkyl, halo-C1-C30-alkyl, halo-C2-C30-alkenyl, and halo-C3-C30-cyclolalkyl, each of which radicals is optionally substituted, the heteroatom being selected from N, O and S; and
the methylene malonate polymer (B) has formula (II), 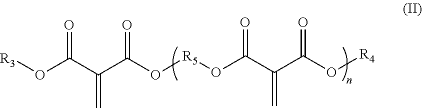
wherein, R₃ and R₄ are, in each case independently selected from the group consisting of C1-C30-alkyl, C2-C30-alkenyl, C3-C30-cyclolalkyl, C2-C30-heterocyclyl, C2-C30-heterocyclyl-C1-C30-alkyl, C6-C30-aryl, C6-C30-aryl-(C1-C30-alkyl), C2-C30-heteroaryl, C2-C30-heteroaryl-C1-C30-alkyl, C1-C30-alkoxy-C1-C30-alkyl, halo-C1-C30-alkyl, halo-C2-C30-alkenyl, and halo-C3-C30-cyclolalkyl, each of which radicals is optionally substituted, the heteroatom being selected from N, O and S,
n is an integer from 1 to 20,
R₅, if n=1 is, or if n >1 are in each case independently, selected from the group consisting of C1-C30-alkylene, C2-C30-alkenylene, C2-C30-alkynylene, C6-C30-arylene, C3-C30-cyclolalkylene, C5-C30-cyclolalkenylene, C5-C30-cyclolalkynylene, C2-C30-heterocyclylene, and C2-C30-heteroarylene, each of which radicals is optionally substituted, the heteroatom being selected from N, O and S, wherein R₅ is optionally interrupted by a radical selected from N, O and S.

3. The composition according to claim 2, wherein R₁ and R₂ are in each case independently selected from the group consisting of C1-C10-alkyl, C2-C10-alkenyl, C3-C10-cyclolalkyl, C2-C10-heterocyclyl, C2-C10-heterocyclyl-C1-C10-alkyl, C6-C18-aryl, C6-C18-aryl-C1-C10-alkyl, C2-C10-heteroaryl, C2-C10-heteroaryl-C1-C10-alkyl, C1-C10-alkoxy-C1-C10-alkyl, halo-C1-C10-alkyl, halo-C2-C15-alkenyl and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S;
R₃ and R₄ are in each case independently selected from the group consisting of C1-C10-alkyl, C2-C10-alkenyl, C3-C10-cyclolalkyl, C2-C10-heterocyclyl, C2-C10-heterocyclyl-C1-C10-alkyl, C6-C10-aryl, C6-C10-aryl-C1-C10-alkyl, C2-C10-heteroaryl, C2-C10-heteroaryl-C1-C10-alkyl, C1-C10-alkoxy-C1-C10-alkyl, halo-C1-C10-alkyl, halo-C2-C10-alkenyl, and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S;
n is an integer from 1 to 15;
R₅, if n=1 is, or if n >1 are in each case independently, selected from the group consisting of C1-C10-alkylene, C2-C10-alkenylene, C2-C10-alkynylene, C6-C18-arylene, C3-C10-cyclolalkylene, C5-C10-cyclolalkenylene, C5-C10-cyclolalkynylene, C2-C10-heterocyclylene, and C2-C10-heteroarylene, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S.

4. The composition according to claim 2, wherein R₁ and R₂ are in each case independently selected from the group consisting of C1-C6-alkyl, C2-C6-alkenyl, C3-C6-cyclolalkyl, C3-C6-heterocyclyl, C3-C6-heterocyclyl-C1-C6-alkyl, C6-C8-aryl, C6-C8-aryl-C1-C6-alkyl, C3-C6-heteroaryl, C3-C6-heteroaryl-C1-C6-alkyl, C1-C6-alkoxy-C1-C6-alkyl, halo-C1-C6-alkyl, halo-C2-C6-alkenyl, and halo-C3-C6-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, the heteroatom being selected from N, O and S;
R₃ and R₄ are in each case independently selected from the group consisting of C1-C6-alkyl, C2-C6-alkenyl, C3-C6-cyclolalkyl, C3-C6-heterocyclyl, C33-C6-heterocyclyl-C1-C6-alkyl, C6-C8-aryl, C6-C8-aryl-C1-C6-alkyl, C3-C6-heteroaryl, C3-C6-heteroaryl-C1-C6-alkyl, C1-C6-alkoxy-C1-C6-alkyl, halo-C1-C6-alkyl, halo-C2-C6-alkenyl, and halo-C3-C6-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, the heteroatom being selected from N, O and S;
n is an integer from 1 to 10;
R₅, if n=1 is, or if n >1 are in each case independently, selected from the group consisting of C1-C6-alkylene, C2-C6-alkenylene, C2-C6-alkynylene, C6-C8-arylene, C3-C6-cyclolalkylene, C5-C6-cyclolalkenylene, C5-C6-cyclolalkynylene, C2-C6-heterocyclylene, and C3-C6-heteroarylene, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkyny, the heteroatom being selected from N, O and S, wherein R₅ is optionally interrupted by a radical selected from N, O and S.

5. The composition according to claim 2, wherein R₁ and R₂ are in each case independently selected from the group consisting of C1-C6-alkyl, C3-C6-cyclolalkyl;
R₃ and R₄ are in each case independently selected from the group consisting of C1-C6-alkyl;
n is an integer from 1 to 8; and
R₅, if n=1 is, or if n >1 are in each case independently, selected from the group consisting of C1-C6-alkylene and C6-C8-arylene, each of which radicals is optionally substituted by at least one C1-C6-alkyl.

6. The composition according to claim 1, wherein the acidic stabilizer (C) is at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, dichloroacetic acid and a mixture thereof.

7. The composition according to claim 1, wherein the cement (D) further comprises lime, aggregates, fillers and/or other additives.

8. The composition according to claim 1, wherein the cement (D) is in an amount of from 1% to 70 wt. %, based on the total weight of the composition.

9. The composition according to claim 1, wherein the monomer (A) is in an amount of from 0 to 70 wt. % based on the total weight of the monomer (A) and the polymer (B).

10. The composition according to claim 1, wherein the acidic stabilizer (C) is in an amount of from 0.1 to 500 ppm.

11. The composition according to claim 1, wherein the monomer (A) is in an amount of from 0 to 40 wt. % based on the total weight of the monomer (A) and the polymer (B), and cement (D) is in an amount of from 1 to 30 wt. %, based on the total weight of the composition.

12. The composition according to claim 11, wherein the composition has a gel time of no less than 20 min.

13. The composition according to claim 11, wherein the composition is used as surface protection material, particularly in flooring, roofing, coating, primer, waterproofing, wall paint and the like.

14. The composition according to claim 1, where in the monomer (A) is in an amount of from 0 to 70 wt. % based on the total weight of the monomer (A) and the polymer (B), and cement (D) is in an amount of from 30 to 70 wt. %, based on the total weight of the composition.

15. The composition according to claim 14, wherein the composition has a Shore D hardness of more than 60 after 24 hours.

16. The composition according to claim 15, wherein the composition's Shore D hardness after 3 hours is no less than 50% of its Shore D hardness after 24 hours.

17. The composition according to claim 14, wherein the composition is used as structural consolidation material.

18. The composition according to claim 14, wherein the composition is used in underground constructions.

19. The composition according to claim 1, where in the components (A)-(D) are packed into two independent packages, one package having monomer (A), polymer (B), acidic stabilizer (C) and the other package having cement (D).

20. A mixture comprising the composition according to claim 1.

21. The mixture according to claim 20, wherein the mixture is substantially absence of any solvent.

22. A process for preparing the composition according to claim 1 comprising steps of:
(1) mixing the monomer (A), the polymer (B) and the acidic stabilizer (C); and
(2) mixing the cement (D) and optional additives with the mixture obtained in step (1) to obtain the composition.

23.-28. (canceled)
